(19) United States
(12) Patent Application Publication
(10) Pub. No.: US 2009/0236285 A1
(43) Pub. Date: Sep. 24, 2009

(54) ETHANOL SEPARATION BY A MIXED MATRIX MEMBRANE

(75) Inventors: Qinbai FAN, Chicago, IL (US); Shiguang LI, Mount Prospect, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE, Des Plaines, IL (US)

(21) Appl. No.: 12/051,207

(22) Filed: Mar. 19, 2008

(51) Int. Cl. B01D 15/00; B01D 39/16

(52) U.S. Cl. 210/640; 210/500.25

(57) ABSTRACT

A mixed matrix membrane including at least one layer of a porous carbon-based structure and a plurality of silicalite crystals dispersed on a surface of the porous carbon-based structure and/or within the porous carbon-based structure. The membrane is suitable for use in processes involving the separation of ethanol from ethanol-containing mixtures.

### BACKGROUND OF THE INVENTION

1. Field of the Invention

This invention relates in one aspect to mixed matrix membranes comprising all-silica zeolite particles dispersed on or within a carbon-based structure. In another aspect, this invention relates to a method for separation of ethanol from a mixture comprising ethanol. In yet another aspect, this invention relates to a method for separation of ethanol from a mixture comprising ethanol using a mixed matrix membrane comprising all-silica zeolite particles dispersed on or within a carbon-based structure.

2. Description of Related Art

Fuel-grade ethanol has gained attention recently because it can be used as a reliable energy source and it is being used currently as a replacement for methyl t-butyl ether as a fuel oxygenate. The current ethanol production capacity in the United States is about 20.4 billion L/year, most of which is produced from corn. Biorefineries under construction or expansion account for another 22.7 billion L/year, and many more biorefineries are in the planning stages. Most biomass-to-ethanol conversion processes involve the fermentative production of ethanol from biomass sugars. Depending upon the source of the biomass and hydrolysis procedures employed, the concentration of ethanol in the resulting fermentation broth is typically in the range of about 1.0 wt % to about 15.0 wt %. In order to produce fuel grade ethanol, the ethanol must be recovered from these fermentation broths.

The technology currently employed by industry for recovering ethanol from dilute biomass fermentation broths is distillation with molecular sieve adsorption used to remove water down to fuel-grade levels. As an alternative to distillation, pervaporation, a membrane process in which liquid is disposed on one side of the membrane and vapor is disposed on the opposite side of the membrane, may be used. Pervaporation is a separation process in which a liquid feed mixture containing two or more miscible components to be separated is placed in contact with one side, also referred to herein as the “feed side” or “retentate side”, of a non-porous polymeric membrane or molecularly porous inorganic membrane (such as a zeolite membrane) while a vacuum or gas purge is applied to the other side, also referred to herein as the “permeate side”. The components in the liquid stream sorb into or onto the membrane, permeate through the membrane, and evaporate into the vapor phase. The resulting vapor, i.e. permeate, may then be condensed.

Several membrane materials for recovering organic compounds from water by pervaporation are known, the current benchmark being poly(dimethyl siloxane) (PDMS), which is an elastomeric material which can be used to fabricate hollow fiber, tubular, unsupported sheet and thin layer supported sheet membranes. Although no organic membrane has yet been demonstrated as being better than PDMS, inorganic membranes employing hydrophobic zeolites, e.g. silicalite-1 and Ge-ZSM-5, have shown both higher ethanol-water separation factors and ethanol fluxes than PDMS membranes. However, manufacturing defect-free such membranes on a commercial scale has proven to be difficult and expensive, as a result of which many skilled in the art have turned to mixed matrix membranes. See, for example, U.S. Pat. No. 4,925,562 which teaches a pervaporation process utilizing a membrane material having molecular-sieve properties and comprising zeolite embedded in a polymer matrix comprising silicon rubber and U.S. Patent Application Publication 2007/0031954 A1 which teaches a process for recovering ethanol using a combination of steps including fermentation, membrane separation, dephlegmation and dehydration.

In accordance with the teachings of U.S. Pat. No. 6,117,328, pervaporation as a method of separation requires the use of non-porous (dense) membranes because pervaporation works on a solution-diffusion-dissolution-evaporation mechanism or an adsorption-diffusion-desorption-evaporation mechanism rather than on pore-diffusion as in conventional porous membranes. Pervaporation membranes permit very high separation efficiency for volatile organic compounds, which efficiencies cannot be obtained by porous membranes. The membrane taught by the '328 patent comprises a hydrophobic adsorbent (filler) such as activated carbon uniformly dispersed into a polymer matrix. U.S. Pat. No. 5,755,967 teaches the use of a silicalite filled polymer membrane for the selective recovery of acetone and butanol from aqueous solutions thereof.

Notwithstanding the gains that have been made in the use of membranes for pervaporation processes, particularly with respect to distillation processes, there remains room for improvements in efficiencies. In addition, due to the materials used to produce the membranes, costs for producing the membranes remain relatively high.

### SUMMARY OF THE INVENTION

Accordingly, it is one object of this invention to provide a membrane for use in pervaporation processes which is more efficient than known membranes.

It is another object of this invention to provide a membrane for use in pervaporation processes which is less costly than known membranes.

These and other objects of this invention are addressed by a mixed matrix membrane comprising at least one layer of a carbon-based structure and a plurality of silicalite crystals dispersed on the surface of the carbon-based structure and/or within the interior of the carbon-based structure. Both silicalite crystals and graphite are highly hydrophobic materials. Thus, with ethanol/water mixtures, ethanol preferentially permeates the membrane and blocks the permeation of water. In addition, the material provides a high ethanol/water separation factor and is effective in recovering bioethanol produced from biomass fermentation.

### BRIEF DESCRIPTION OF THE DRAWINGS

These and other objects and features of this invention will be better understood from the following detailed description taken in conjunction with the drawings wherein:

FIG. 1 is a diagram showing water and isopropanol vapor adsorption isotherms on silicalite-1;

FIG. 2 is a schematic diagram of the separation process in accordance with one embodiment of this invention; and

FIG. 3 is a diagram showing the energy requirements for recovering ethanol from water as a function of ethanol concentration in the feed stream for two heat-integrated distillation systems and membrane separation at several ethanol-water separation factors (Vane, L. M. et al., “Hydrophobic zeolite-silicone rubber mixed matrix membranes for ethanol-water separation: Effect of zeolite and silicone component selection on pervaporation performance,” Journal of Membrane Science, Vol. 308, Issues 1-2, February 2008, pp. 230-241).

### DETAILED DESCRIPTION OF THE PRESENTLY PREFERRED EMBODIMENTS

As used herein, the term “carbon-based structures” refers to inorganic structures comprising carbon. Preferred carbon-based structures are structures comprising carbon selected from the group consisting of carbon black, graphites, carbon fibers, carbon cloth, and combinations and mixtures thereof.

In referring to the side of the membrane of this invention to which the ethanol-containing mixture is introduced or fed, the terms “feed side” and “retentate side” are used interchangeably.

Silicalites, also known as zeolites, are molecular sieves and have the capability to adsorb organic solvents, such as ethanol, propanol, methanol, acetone, butanol, etc. from aqueous solutions.

Ethanol/water separation in accordance with one embodiment of the method of this invention comprises contacting a feed side of a mixed matrix membrane with the ethanol/water mixture and passing substantially only the ethanol through the mixed matrix membrane to the permeate side of the mixed matrix membrane, whereby the water is retained on the retentate side of the mixed matrix membrane. To ensure passage of the ethanol to the permeate side of the membrane, the permeate side of the membrane is at a lower pressure than the feed side of the membrane.

The mixed matrix membrane of this invention comprises at least one layer of a porous carbon-based structure and a plurality of silicalite crystals dispersed on the surface of the porous carbon-based structure and/or within the interior of the porous carbon-based structure. In accordance with one embodiment of this invention, the silicalite crystals form a substantially continuous layer on the surface of the carbon-based structure. In accordance with one preferred embodiment of this invention, the substantially continuous layer of silicalite crystals is a monolayer, i.e. a layer having a thickness of one molecule. Requirements for the porous carbon-based structure are thermal stabilty and stiffness. Thermal stability is important due to the high temperatures, e.g. 370° C., required to produce the membrane. The porous carbon-based structure also should be substantially inflexible because the continuous zeolite layer applied to the porous carbon-based structure is very brittle. In accordance with one embodiment of this invention, the porous carbon-based structure is a structure selected from the group consisting of a composite porous graphite foam, carbon fiber paper, carbon cloth, and combinations thereof.

Porosity of the carbon-based structure is in the range of about 15% to about 80%. It will, however, be appreciated that as the porosity of the carbon-based structure decreases the transport resistance of the membrane will increase; thus, porosities towards the higher end of the range, about 30% to about 80%, are generally preferred. Porosities above about 80% are undesirable due to the potential for allowing compounds other than ethanol to penetrate through the membrane. Pore sizes of the pores of the carbon-based structure is also a critical factor; pore sizes that are too large increase the potential for the water in the ethanol/water mixture to pass through the membrane whereas pore sizes that are too small will prevent the ethanol from passing through the membrane. Accordingly, in accordance with one embodiment of this invention, the pore sizes of the pores of the porous carbon-based structure are in the range of about 0.1 μm to about 5.0 μm. In accordance with one preferred embodiment, pore sizes are in the range of about 0.2 μm to about 0.5 μm.

Production of thin, defect-free membranes in accordance with this invention requires the use of nano-scale silicalite seeds or particles as a starting material. In accordance with one embodiment of this invention, particle sizes of the seed silicalite particles is in the range of about 50 nm to about 500 nm. In accordance with one preferred embodiment, particle sizes of the seed silicalite particles are in the range of about 80 nm to about 120 nm.

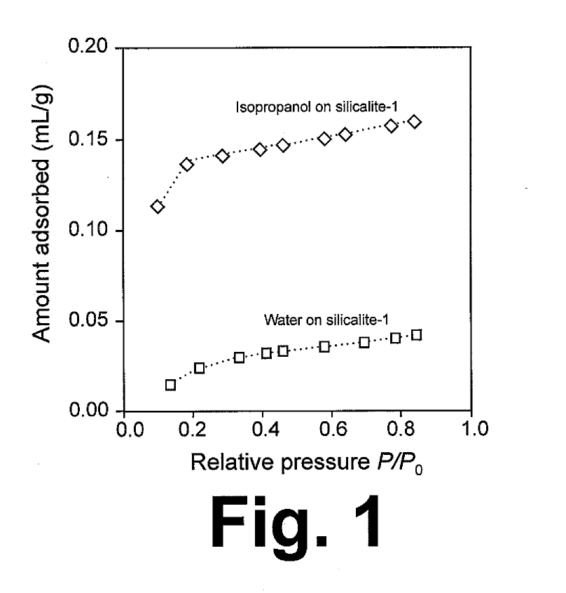

As previously indicated, silicalite and graphite are both hydrophobic. Water and isopropanol vapor adsorption isotherms on silicalite-1 powder at 298° K are shown in FIG. 1. As can be seen, the amounts of isopropanol adsorbed on silicalite-1 at high pressures were approximately four times the amounts of water adsorbed. That is, silicalite-1 preferentially adsorbs isopropanol over water. In liquid mixtures of ethanol and water, the silicalite-1 should perform in the same fashion, preferential adsorption of ethanol over water.

In a separate study, pure ethanol and water were dropped onto a graphite disk. It was observed that water stayed on the graphite disk whereas ethanol permeated through the graphite, thus confirming the hydrophobicity of graphite.

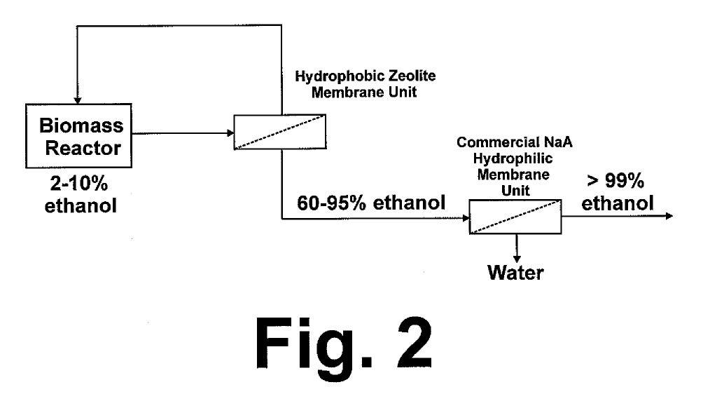

FIG. 2 shows a schematic diagram of a process for recovering ethanol during fermentation to maintain ethanol concentrations at lower levels which promote more efficient production of ethanol by the microbes employed in the fermentation process. As shown therein, the mixed matrix membrane of this invention is expected to increase the ethanol concentration from a range of about 2.0-10% to a range of about 60-95%. A commercially available NaA hydrophilic membrane may be used downstream of the mixed matrix membrane of this invention to remove water so that the final product has an ethanol concentration greater than 99%.

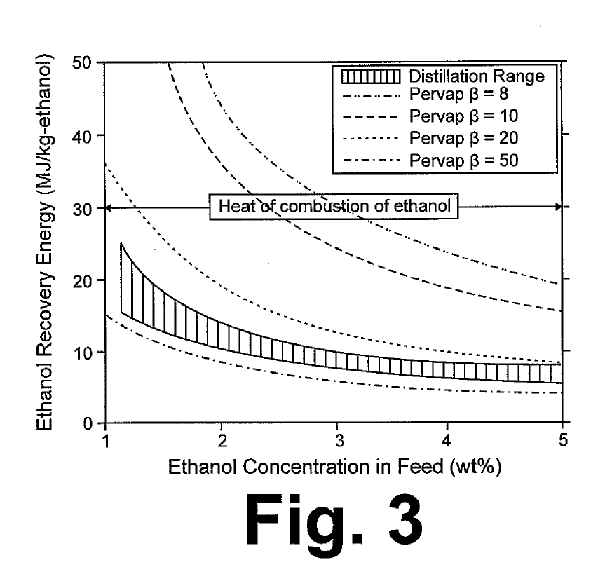

In FIG. 3, energy requirement estimates for 95% ethanol recovery by membrane separation for separation factors of 8, 10, 20, and 50 are shown for a feed ethanol concentration in the range of about 1.0 wt % to about 5.0 wt %. Also shown are the energy requirements for a large-scale, heat-integrated distillation system as reported in the literature. As shown, membranes with a separation factor (β) greater than 20 are required to yield the same efficiency as distillation. For fermentation broths containing 3% ethanol, membranes having a separation factor of 50 save about 40% of the energy compared with the energy consumed by distillation. The higher the separation factor, the greater will be the amount of energy saved. A separation factor of 50 equates to an enhanced ethanol concentration of about 60% on the permeate side of the mixed matrix membrane.

### Membrane Preparation

Carbon fiber paper (AVCARB™ P50T) obtained from Ballard Material Products Inc. (Lowell, Mass.) having a porosity of 66% and athickness of 0.33 mm was pretreated by placement in a boiling HNO₃ solution (70 wt %) for 16 hours in order to create oxygen groups on the surface. Thereafter, the carbon fiber paper was washed with distilled water and dried for 1 hour at 100° C. The treated carbon fiber paper was seeded by rubbing one side with nano-scale silicalite crystals. The seeded carbon fiber paper was then placed in an autoclave and filled with synthesis gel having a molar composition of 1.0 tetrapropylammonium hydroxide (TPAOH): 19.5 SiO₂:438 H₂O for hydrothermal treatment. The gel was prepared by adding colloidal silica sol (LUDOX AS40, 40% aqueous solution) to H₂O at room temperature for 5 minutes after which the template, TPAOH, was added to the mixture. The solution was sealed, stirred and aged for about 3 hours at room temperature before use. The hydrothermal synthesis was carried out at 468° K for a certain time as shown in Table 1. After synthesis, the membrane was washed with distilled water at room temperature and dried at 373° K in an oven for 1 hour. The synthesis was repeated (twice) until an uncalcined membrane, after drying at 373° K was impermeable to N₂ for a 138-kPa pressure drop at room temperature. Because the TPAOH template filled the silicalite pores during the synthesis process and, thus, blocked gas permeation, a membrane with no defects should also be impermeable. However, the template could also fill pores that are larger than the silicalite pores. After completion of the zeolite synthesis, the membrane was washed, dried, and calcined in air to remove the template from the pores. The calcination procedure was carried out in a muffle furnace with heating and cooling rates of 0.9 ° K/min. The maximum temperature was 643° K, and the membrane was held at this temperature for 8 hours.

TABLE 1
Crystallization Conditions for Silicalite/Carbon Membranes

| Membrane | 1st Synthesis | 2nd Synthesis | 3rd Synthesis |
|---|---|---|---|
| A | 24 hours | 24 hours | 12 hours |
| B | 8 hours | 24 hours | 12 hours |

In accordance with one embodiment of this invention, the porous carbon-based structure is a composite porous graphite foam. The composite porous graphite foam may be produced by casting a graphite slurry which is a mixture of 5 to 30% (W/W) polybenzimidazole (PBI) with graphite powders (<10 μm) in a 3% NaOH/EtOH solution.

In accordance with one embodiment of this invention, the porous carbon-based structure is carbon fiber paper or carbon cloth which is coated by a layer of carbon black or graphite powder with PBI binder to match the silicalite coating particle size.

### EXAMPLE

Silicalite/carbon fiber paper membranes in accordance with one embodiment of this invention were used to separate 3 wt % ethanol from water by pervaporation. The membranes were sealed in a permeation cell with VITON O-rings. The ethanol/water mixture was fed to one side, the retentate side, of the membrane by a pump. A vacuum pump evacuated the other side, the permeate side, of the membrane to a pressure of approximately 0.2 kPa. A liquid nitrogen cold trap condensed the permeate vapor and maintained the vacuum on the permeate side of the membrane. A permeate sample was usually collected and weighed every hour to determine the permeation flux. Permeation concentrations were measured by off-line HPLC. The separation properties of the silicalite/carbon fiber membranes are shown in Table 2. Membranes A and B were selective for ethanol over water since the ethanol concentrations were higher in the permeate than in the feed (3 wt %).

TABLE 2
Separation Properties of Silicalite/Carbon Fiber Paper Membrane

Separation of 3 wt % ethanol/water

| | | Ethanol permeate |
|---|---|---|
| Membrane | Flux (kg/m²/h) | concentration (wt %) |
| A | 0.45 | 7.5 |
| B | 0.75 | 6.2 |

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A mixed matrix membrane comprising:
at least one layer of a porous carbon-based structure; and
a plurality of silicalite crystals dispersed at least one of on a surface of said porous carbon-based structure and within said porous carbon-based structure.

2. The mixed matrix membrane of claim 1, wherein said porous carbon-based structure has a porosity in a range of about 15% to about 80%.

3. The mixed matrix membrane of claim 2, wherein pore sizes of the pores of said porous carbon-based structure are in a range of about 0.1 μm to about 5 μm in diameter.

4. The mixed matrix membrane of claim 1, wherein said silicalite crystals form a substantially continuous silicalite layer on said surface of said porous carbon-based structure.

5. The mixed matrix membrane of claim 1, wherein said membrane has one of a disk shape and a tubular shape.

6. The mixed matrix membrane of claim 1, wherein said carbon-based structure comprises carbon selected from the group consisting of carbon black, graphites, carbon fibers, carbon cloth, and combinations and mixtures thereof.

7. The mixed matrix membrane of claim 6, wherein said carbon-based structure is a structure selected from the group consisting of a composite porous graphite foam, carbon fiber paper, carbon cloth, and combinations thereof.

8. The mixed matrix membrane of claim 4, wherein said substantially continuous silicalite layer on said surface of said porous carbon-based structure is a monolayer.

9. A method for separation of ethanol from a mixture comprising said ethanol, the method comprising the steps of:
contacting a feed side of a mixed matrix membrane with said mixture, said mixed matrix membrane comprising at least one layer of a porous carbon-based structure and a plurality of silicalite crystals dispersed at least one of on a surface of said porous carbon-based structure and within said porous carbon-based structure; and
passing substantially only said ethanol through said mixed matrix membrane to a permeate side of said mixed matrix membrane, whereby a remaining portion of said mixture is retained on said retentate side of said mixed matrix membrane.

10. The method of claim 9, wherein said permeate side of said mixed matrix membrane is at a lower pressure than said feed side of said mixed matrix membrane.

11. The method of claim 9, wherein said ethanol comprises in a range of about 1.0 wt % to about 15.0 wt % of said mixture.

12. The method of claim 9, wherein said carbon-based structure is a structure selected from the group consisting of a composite porous graphite foam, carbon fiber paper, carbon cloth, and combinations thereof.

13. The method of claim 9, wherein said mixture consists of ethanol and water.
